(19) United States
(12) Patent Application Publication
(10) Pub. No.: US 2018/0058894 A1
(43) Pub. Date: Mar. 1, 2018

(54) GAS FLOW SENSOR HOUSING AND ASSEMBLY PROVIDING REDUCED TURBULENCE

(71) Applicant: ATREX ENERGY, INC., Walpole, MA (US)

(72) Inventors: Kenneth E. Pearson, Shingle Springs, CA (US); Anthony F. Litka, Hanover, MA (US); Duncan D. MacGregor, Shingle Springs, CA (US); Paul A. Getchel, Placerville, CA (US)

(21) Appl. No.: 15/690,941

(22) Filed: Aug. 30, 2017

Related U.S. Application Data
(60) Provisional application No. 62/381,992, filed on Aug. 31, 2016.

(51) Int. Cl. G01F 15/14; G01F 1/684; G01F 1/688

(52) U.S. Cl. CPC G01F 15/14; G01F 1/6888; G01F 1/6845

(57) ABSTRACT

A gas flow sensor housing and assembly including a gas flow sensor for measuring gas flow is disclosed. The housing includes a gas flow sensor mounting portion having a recess configured for mounting the gas flow sensor therein. The sensor includes a gas flow sensing element mounted to a substrate which is within the recess so as to avoid turbulence in the vicinity of the sensing element resulting from impingement of gas flow on a blunt or rough edge of the substrate. The gas flow sensor mounting portion includes opposed first and second edge portions, at least one of which is smoothly contoured to reduce turbulence in the vicinity of the sensing element. A method for measuring gas flow is also disclosed that employs the disclosed housing and sensor assembly.

### STATEMENT REGARDING FEDERALLY SPONSORED RESEARCH OR DEVELOPMENT

Not Applicable

### BACKGROUND OF THE INVENTION

The present invention relates to fluid flow sensors and more particularly to a fluid flow fluid flow sensor assembly that includes a fluid flow sensor housing that provides reduced turbulence in the vicinity of a fluid flow sensor mounted to the housing.

Prior art insertion flow sensors have included a sensor die mounted on a printed circuit board (PCB) to form a sensor board assembly. The sensor board assembly is then positioned relative to the flow of a gas to enable the gas to flow over and/or across the sensor die. The sensor die may include a central heater source such as a micro-heater and first and second temperature sensors disposed respectively upstream and downstream relative to the micro-heater. As gas flows across the sensor die, differential temperature readings are obtained from upstream and downstream temperature sensing elements of the sensor. An electronic output signal is generated by the flow sensor which is indicative of the temperature differential and reflective of the mass flow rate of the gas.

Ideally, gas flow across the sensor die is laminar. :If turbulent gas flow around the sensor die is present, inaccuracies in the measurement of the gas mass flow rate may occur. Such inaccuracies are aggravated as turbulence increases in the vicinity of the sensor die.

### BRIEF SUMMARY OF THE INVENTION

A housing for an insertion flow sensor and a gas flow sensor assembly is disclosed. The housing includes a body member having a first portion configured for mounting in a manifold and a second portion configured to receive a gas flow sensor such as an insertion flow sensor (IFS). The second portion extends from the first portion and includes a leading edge and a trailing edge. When the gas flow sensor assembly is installed and in use with the second portion at least partially disposed in a gas flow channel, gas flow proceeds in a direction from the leading edge toward the trailing edge of the second portion. The second portion of the housing includes a recess or slot between the leading and trailing edge portions, the recess being sized and configured to receive the gas flow sensor therein.

The second portion of the gas flow sensor assembly extends into the gas flow channel in which a flow rate of the gas is to be measured. At least the leading edge of the second portion of the housing includes smoothly contoured edges, a convex cross-section or an airfoil shape configured to reduce gas flow turbulence and promote a laminar flow of gas past the gas flow sensor disposed in the housing when the gas flow sensor assembly is in use.

The first portion of the housing includes a passageway or opening to accommodate electrical connections between the gas flow sensor and control electronics. A first seal is provided in the passageway or opening which is configured to accommodate the electrical connections to the gas flow sensor while preventing gas leakage through the passageway or opening. The first seal may be provided in the form of a conformable and curable material, such as silicone, rubber, plastic or any other suitable material.

The first portion of the housing is configured to accommodate a second seal that prevents leakage of gas between the outer circumference or periphery of the first portion and a manifold in which the gas flow sensor assembly is mounted. The second seal may comprise one or more O-rings disposed in annular circumferential channels, a conformal and curable material such as employed for the first seal or any other suitable sealing material.

### BRIEF DESCRIPTION OF THE SEVERAL VIEWS OF THE DRAWINGS

Non-limiting embodiments of the present invention will be described by way of example with reference to the accompanying figures, which are schematic and are not intended to be drawn to scale. For purposes of clarity, not every component is labeled in every figure, nor is every component of each embodiment of the invention shown where illustration is not necessary to allow those of ordinary skill in the art to understand the invention. In the figures:

FIG. 1 is a perspective view of a gas flow sensor assembly in accordance with one embodiment of the present invention;

FIG. 2 is exploded perspective view of the gas flow sensor assembly of FIG. 1;

FIG. 3 depicts the gas flow sensor assembly of FIG. 1 disposed within a manifold of a fluid flow meter wherein the gas flow sensor assembly is illustrated in a side view and the manifold is illustrated in cross-section;

FIG. 4 is a side view of the gas flow sensor assembly of FIG. 1;

FIG. 5 is a partially exploded side view of the gas flow sensor assembly of FIG. 1 illustrating an intermediate step in the fabrication of the gas flow sensor assembly;

FIGS. 6a-6e depict exemplary alternative cross-sections of a leading or first edge portions of the housing for the gas flow sensor assembly of FIG. 1;

FIG. 7 is schematic view illustrating in cross-section, the gas flow sensor assembly having an axis angled within the gas flow channel with respect to the direction of gas flow;

FIG. 8 is an exploded perspective view illustrating a gas flow manifold and a gas flow sensor assembly with a header mounted to a printed circuit board containing measurement electronics;

FIG. 9 is a graph showing voltage output data as measured with a prior art gas flow sensor; and

FIG. 10 is a graph showing voltage output data as obtained using a gas flow sensor assembly in accordance with the present invention.

### DETAILED DESCRIPTION OF THE INVENTION

The present application hereby incorporates by reference, in its entirety, U.S. provisional application No. 62/381,992 filed Aug. 31, 2016 and titled Gas Flow Sensor Housing and Assembly Providing Reduced Turbulence.

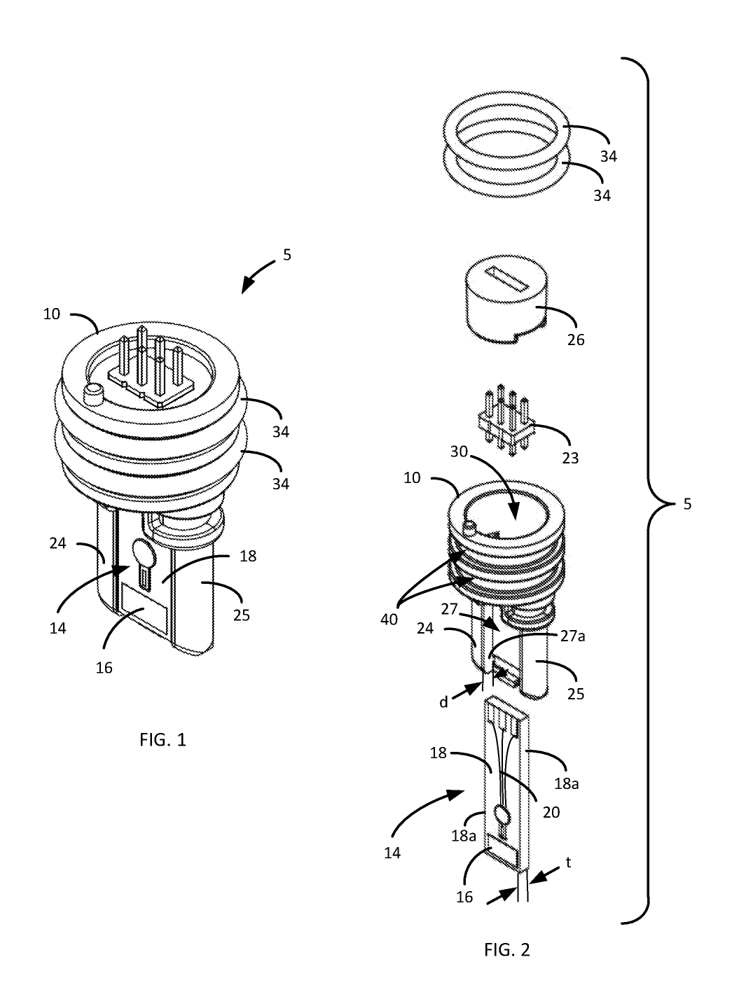

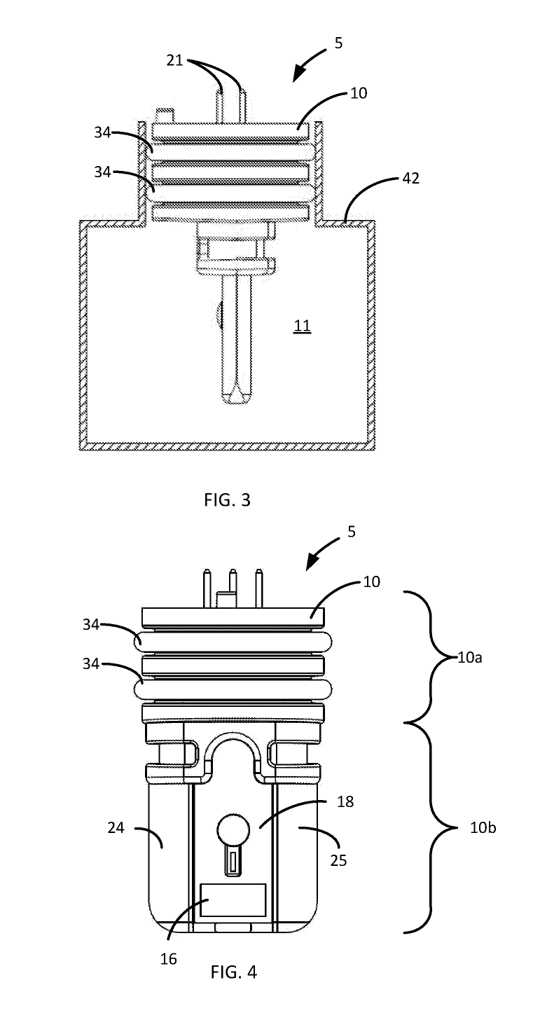

The present invention features a gas flow sensor assembly (5) including a gas flow sensor housing (10) adapted for mounting an insertion flow sensor (IFS) (14) therein, as shown in FIGS. 1 through 4. The IFS (14) in the illustrated embodiment includes a sensing element (16), such as a sensor die, mounted on a substrate or sensor board (18), such as a printed circuit board (PCB). The illustrated IFS sensing element (16) comprises a thermal gas flow sensor as known in the art. More specifically, the IFS sensor (14) may include first and second thermal sensing elements within the sensing element (16) as known in the art which are operative to produce an electrical signal indicative of a differential temperature between the first and second sensing elements. By way of example and not limitation, the thermal mass gas flow sensor may comprise a sensor manufactured by POSiFA Microsystems, Inc., of San Jose, Calif. and identified as Model PTFD21 or any other suitable thermal mass gas flow sensor known in the art.

The housing (10) includes a first housing portion (10a) configured for mounting in a manifold or body (42) of a flow meter and a second housing portion (10b) that extends from the first housing portion (10a) into a gas flow channel (11) when mounted in the manifold (42). The second housing portion (10b) of the housing (10) includes a leading or first edge portion (24) and a trailing or second edge (25) and includes a recess or slot (27) between the first or leading edge portion (24) and the second or trailing or trailing edge portion (25) configured to receive the insertion flow sensor (14). The reference to the leading edge portion refers to the edge portion of the second housing portion (10b) that is first impinged by laminar gas flow in a first direction.

The sensing element (16) of the IFS (14) makes electrical interconnection with conductive contacts (21) provided on the PCB or substrate (18) of the IFS sensor (14) via conductive traces, connections or electrical leads (20). The conductive contacts (21) are adapted for electrical connection to control electronics (See FIG. 8) through a header (23) including header pins (22) and a spacer (22c) as described with greater particularity below. Any other suitable electrical connector for making electrical connection between the IFS (14) and control electronics may alternatively be employed.

The sensing element (16) provides an electrical output signal which is indicative of the mass flow rate of a gas in the gas flow channel (11). In the illustrated embodiment, the electrical output signals from the sensing element (16) are coupled to the control electronics through the header pins (22) of the header (23).

The IFS (14) is used as a thermal mass gas flow sensor when the gas flow sensor assembly (5) is mounted in a manifold (42) with the second housing portion (10b) of the housing (10) positioned such that the gas flow sensing element (16) is disposed in the gas flow channel (11). To obtain accurate gas flow measurements with reduced signal noise, it has been observed that it is desirable for the gas flow across the IFS (14) to be substantially laminar. Thermal mass gas flow sensors use the temperature differential across the sensing element to determine the mass flow rate. Turbulence in the vicinity of the sensing element (16) can undesirably alter the differential temperature across the sensing element (16) producing inaccurate flow measurements and signal noise. Frequently, thermal mass gas flow sensors employ a sensor board that is not well suited for maintenance of laminar flow across the sensing element due to the mechanical configuration of the sensor board. More specifically, sensor boards in thermal mass gas flow sensors typically include edges having blunt, rectangular leading and trailing edges which result from common manufacturing processes, such as V-groove scoring used in the volume production of sensor boards. Impingement of gas flowing on such rough edges can produce undesirable turbulence which adversely affects the accuracy of gas flow measurements.

To reduce turbulence in the vicinity of the sensing element (16), the leading edge portion (24) of the second housing portion (10b) of the housing (10) is provided with substantially smooth contoured edges, a convex cross-section or an airfoil shape so as to reduce turbulence of gas flow in the vicinity of the sensing element (16). The IFS (14) is mounted within the housing (10) such that the sensor board (18) is disposed at least partially within a recess or opening (27) in the second housing portion (10b) of the housing (10) so as to shield the edge of the sensor board (18) from the gas flow. More specifically, the recess (27) is defined by opposing edges (27a) having a depth (d). In one embodiment, the depth d of the recess (27) is equal to or greater than the thickness (t) of the PCB or substrate (18) such that laminar gas flow does not directly impinge upon side edges of the PCB or substrate (18) in a manner to produce turbulence in the vicinity of the sensing element (16) that affects the accuracy of gas flow measurement. In another embodiment, at least a portion of the thickness of the PCB or substrate (18) is disposed within the recess (27).

When the gas flow sensor assembly (5) is mounted in the manifold (42) with the sensing element (16) of the IFS (14) positioned within the gas flow channel, the gas first impinges upon the aerodynamically shaped leading edge (24) of the housing (10) instead of a blunt, rough, and possibly scored surface of the sensor board (18). Additionally, since the edges of the PCB or substrate (18) are disposed with the recess (27), the edges (18a) of the PCB or substrate (18) are at least partially shielded or fully shielded from direct impingement of laminar gas flow within the manifold (42). As a result, turbulence in the vicinity of the sensing element (16) is reduced and a more laminar flow across the sensing element (16) is achieved.

The housing (10) having the aerodynamically shaped leading or first edge portion (24) of the second housing portion (10b) can be manufactured according to methods known to one of ordinary skill in the art including, for non-limiting examples, direct machining, injection molding, casting, and additive manufacturing methods. More specifically, in one embodiment, the housing (10) is formed as a continuous, single piece, integral member via a molding process. The housing (10) of the present invention may be injection molded from 15% glass fiber reinforced Polybutylene Terephthalate (PBT) although any suitable plastic or polymer may be employed. The housing (10) material is selected according to product requirements including, for non-limiting examples, (a) the ability to perform over a wide range of environmental and operational conditions, (b) mechanical strength and/or (c) compatibility with a wide array of chemical elements and/or chemical compounds. By way of example, the housing (10) may be fabricated from a polysulfone (PSU), polyamide-imide (PAI), and polyimide (PI) or any other suitable material. The selected material for the housing (10) can also include reinforcing additives such as, for non-limiting examples, mineral, glass and carbon.

In one embodiment, the housing (10) of the present invention includes a first internal seal (26) and one or more second or external seals, such as O-rings (34), adapted to prevent leakage of gas from the gas flow channel (11) to areas external of the gas flow channel (11).

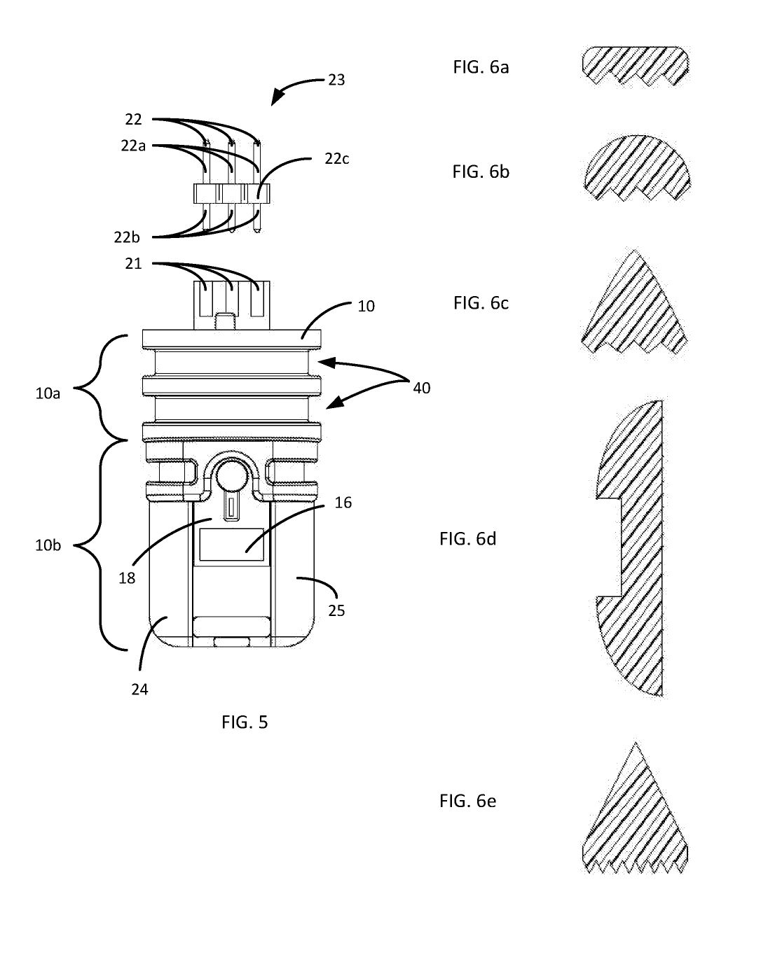

One method of assembling the gas flow sensor assembly (5) is illustrated by reference to FIGS. 4 and 5. Specifically, the IFS (14) in the illustrated embodiment is inserted within the recess or opening (27). The IFS (14) is positioned such that contacts (21) of the IFS (14) PCB (18) are accessible external of the first housing portion (10a) of the housing (10) as illustrated in FIG. 5. The header pins (22) constitute conductive pins including a first portion (22a) disposed on a first side of a spacer (22c) and a second portion (22b) disposed on a second side of the spacer (22c). The first portions (22a) of the header pins (22) are electrically connected to corresponding electrical contacts (21) by, for a non-limiting example, soldering. The IFS (14) is then repositioned downward within the recess (27) as illustrated in FIG. 4. The first seal (26) may be provided in the form of a gasket or a conformal seal, such as a curable silicone, plastic or other suitable material which is capable of flowing and curing. When a conformal seal is employed, the curable material is introduced into opening (30) in the first housing portion (10a) of the housing (10) and allowed to cure. The first seal (26) prevents gas from exiting the housing (10) through the internal opening or passageway (30) of the first housing portion (10a) of the housing (10) when the gas flow sensor assembly is installed within a flow meter body.

When the first seal (26) is a gasket, following interconnection of the header pins (22) to PCB or substrate contacts (21), the IFS (14) may then be repositioned through the gasket (26) within the recess (27) to assume its final mounting position as shown in FIG. 4. The first seal (26) protects the conductive contacts (21) and the first portion (22a) of the header pins (22) from possibly moist and/or other corrosive effects of the gas flowing through the gas flow channel (11) which could compromise the conductive contacts (21) and the header pins (22) over time.

The housing (10) can include one or more second seals (34), such as O-rings, which are disposed in one or more peripheral annular channels (40) formed in the first housing portion (10a) of the housing (10). Alternatively, the one or more second seals (34) may be formed of a conformal material, e.g., a material such as employed to form the first seal (26). The second seal(s) (34) provide a seal between the circumferential periphery of the first housing portion (10a) of the housing (10) and the manifold (42) when the gas flow sensor assembly (5) is mounted within the manifold (42).

In another embodiment, the invention features the housing (10) adapted for bi-directional gas mass flow measurements. In this embodiment, the leading and trailing edges (24) and (25) respectively of the housing (10) are first and second edges portions of the second housing portion (10b), where each of the first and second edge portions has a cross-section that is configured to reduce turbulence in the vicinity of the gas flow sensing element (16). The first and second edge portions (24, 25) may be provided with the same cross-section to accommodate bi-directional gas flow. Thus, the gas flow sensor assembly (5) may be employed for bi-directional gas flow measurement, with gas flowing in the gas flow channel (11) either in a direction from the first edge portion (24) toward the second edge portion (25) of the second housing portion (10b) of the housing (10) or in a direction from the second edge portion (25) toward the first edge portion (24) of the second housing portion (10b) of the housing (10). In one embodiment, the aerodynamic or airfoil cross-sections of the first edge (24) and the second edge (25) are symmetrical. In another embodiment, the aerodynamic or airfoil cross-sections sections of the first edge (24) and the second edge (25) are asymmetrical. The electrical output of the IFS may be bi-polar or offset to indicate the flow direction and magnitude.

FIGS. 6a-6e illustrate exemplary cross-sections of leading edge portions (24) of the second portion (10b) in which the leading edge portions, and optionally, the trailing edge portions, are configured to reduce turbulence of a fluid in a fluid flow channel in the vicinity of a sensing element (16) of an IFS (14).

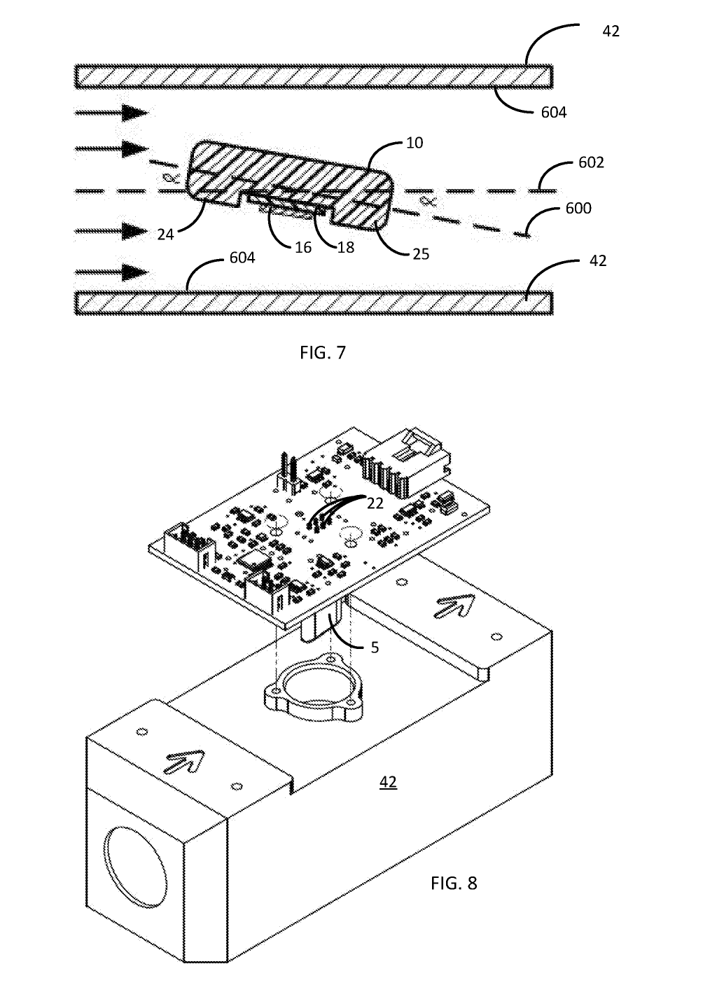

As illustrated in FIG. 7, in one embodiment, the gas flow assembly (5) including the gas flow sensor housing (10), is mounted in the manifold (42) with a longitudinal axis (600) through the leading and trailing edge portions of the gas flow sensor housing (10) disposed in parallel or at an angle α with respect to a longitudinal direction or axis (602) of gas flow (indicated by arrows) within the gas flow channel. The cross-section of the gas flow channel (11) may be circular, rectangular, elliptical, or any other suitable cross-section. In a preferred embodiment, the gas flow sensor housing (10) is disposed in an orientation relative to the walls (604) defining the gas flow channel selected for minimizing or eliminating the introduction of gas flow turbulence around the gas flow sensing element (16). Preferably, the gas flow sensor housing (10) is mounted within the gas flow channel (11) such that the gas flow sensing element (16) is disposed generally centrally within the gas flow channel (11).

In one embodiment, the gas flow sensor assembly (5) is mounted within the gas flow channel (11) such that the longitudinal axis (600) of the gas flow sensor housing (10) is disposed at an angle α with respect to the longitudinal direction (602) of the gas flow channel (11), i.e. the direction of gas flow within the gas flow channel (11), to provide reduced turbulence in the vicinity of the sensing element (16) mounted within the recess (27) of the gas flow sensor housing (10). The angle α of the longitudinal axis (600) with respect to the longitudinal direction (602) is typically set at between 0 degrees and 10 degrees. In one embodiment, the angle α is set at 5 degrees or less to obtain reduced turbulence in the vicinity of the sensing element (16). Thus, the surface of the sensing element (16) is generally parallel to the direction of gas flow within the gas flow channel (11) or slightly angled such that the outer surface of the sensing element (16) is facing but angled with respect to the gas flow within the gas flow channel (11). With the sensor board (18) mounted within the recess (27), the edge (27a) of the recess (27) of the second housing portion (10b) shields the blunt or rough edges (18a) of the sensor board (18) from direct impingement of gas flow within the channel (11) and thus provides reduced turbulence in the vicinity of the sensor element (16). Additionally, the aerodynamically shaped leading edge portions (24) of the second portion (10b) of the housing (10) reduce turbulence in the vicinity of the sensor element (16).

It should be recognized that turbulence reduction in accordance with the present disclosure may be achieved via the use of the above-described sensor assembly (5) having an airfoil shaped leading edge or edges, mounting of the IFS sensor 14 within the recess (27) as discussed above, and/or the selection of the angle α of the longitudinal axis (600) of the sensor housing (10) with respect to the longitudinal direction (602) of gas flow.

While the housing (10) as described above, is adapted for the measurement of the flow rate of a gas, the above-described sensor assembly (5) may also be employed for the measurement of the mass flow rate of a fluid, including a liquid or a gas when an appropriate sensor is employed. It should be recognized that the sensor assembly (5) is equally applicable for the measurement of volumetric flow rates since the mass flow rate is related to the volumetric flow rate for a known fluid and known temperature and pressure conditions by a constant.

### EXAMPLE

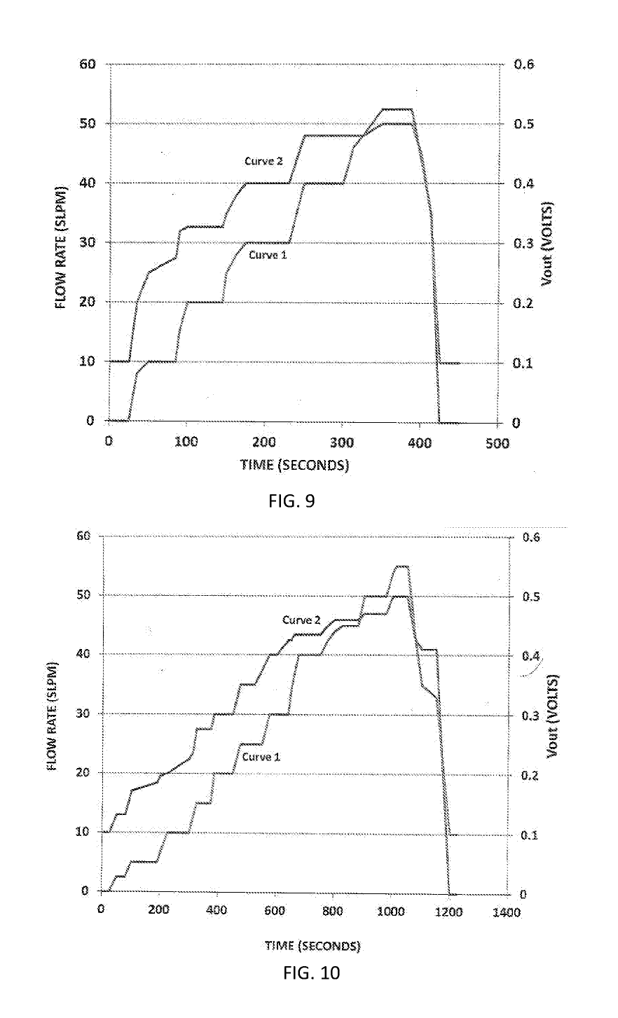

In one example, a gas flow of nitrogen was varied from 0-50 standard liters per minute (SLPM) and directed through a reference flow meter (RFM) for the measurement of gas flow rate. A Yamatake Gas Mass Flowmeter, model CMS0050BSRN2000 was used for the RFM in the tests featured in the example. An IFS was connected in series with the RFM and received substantially the same nitrogen flow rate as the RFM. Results for the tests are shown in FIGS. 9 and 10. In the tests shown in FIG. 9, a standard IFS featured in the prior art was used. In the tests shown in FIG. 10, a gas flow sensor assembly as presently disclosed was used.

In each of FIGS. 9 and 10, curve 1 represents the RFM measurements in SLPM as indicated by the left vertical axes. In each of FIG. 9 and FIG. 10, curve 2 represents the IFS measurements in electrical output voltage as indicated by the right vertical axes. The horizontal axis of each of FIGS. 9 and 10 indicate the sample counts for the measured RFM and IFS data.

FIG. 9 demonstrates noticeable output noise in the IFS output signal when the standard prior art IFS was used. Further, the output noise increases as the flow rate of the nitrogen increases. Notably, turbulent flow which induces output noise becomes more significant as gas flow rate increases.

FIG. 10 illustrates that the IFS output noise is significantly reduced when a gas flow sensor assembly in accordance with the presently disclosed gas flow sensor assembly is used. The decreased noise reduction is maintained even as gas flow rate increases.

The foregoing examples and detailed description are not to be deemed limiting of the invention which is defined by the following claims. The invention is understood to encompass such obvious modifications thereof as would be apparent to those of ordinary skill in the art.

What is claimed is:

1. Apparatus for use in measuring fluid flow in a first direction through a fluid flow channel, the apparatus for use with a fluid flow sensor including a substrate having a side edge with a thickness t and a fluid flow sensing element disposed on the flow fluid sensor substrate, the apparatus comprising:
a housing for the fluid flow sensor, the housing including first and second housing portions,
the first housing portion having a periphery configured for sealing engagement within a fluid flow meter; and
the second housing portion extending from the first housing portion and configured so as to extend into the fluid flow channel when the first housing portion is mounted within the fluid flow meter, the second housing portion defining a recess having a depth d, the recess sized and configured for mounting the substrate at least partially within the recess of the second housing portion.

2. The apparatus of claim 1 wherein the first and second housing portions are an integral continuous, one piece member.

3. The apparatus of claim 1 wherein the first and second housing portions are formed of polysulfone, polyamide-imide or polyimide.

4. The apparatus of claim 1 further including the fluid flow sensor, the fluid flow sensor substrate mounted to the housing and disposed at least partially within the recess so as to reduce impingement of a fluid on at least a portion of the side edge of the substrate when the apparatus is in use within the fluid flow meter.

5. The apparatus of claim 2 wherein the fluid flow sensor comprises a gas flow sensor.

6. The apparatus of claim 5, wherein the gas flow sensor is an insertion flow sensor (IFS).

7. The apparatus of claim 4 wherein the depth d is less than the thickness t.

8. The apparatus of claim 4 wherein the depth d of the recess is greater than or equal to the thickness t.

9. The apparatus of claim 4 wherein the second housing portion includes first and second opposed edge portions defining the recess therebetween and a housing longitudinal axis therethrough, wherein at least one of the first and second opposed edge portions includes a smoothly contoured edge surface configured to reduce fluid turbulence in the vicinity of the fluid flow sensing element in the presence of fluid flow in the first direction with the housing longitudinal axis generally parallel to the first direction.

10. The apparatus of claim 9 wherein the smoothly contoured edge surface includes a cross-section having rounded corners, a generally semi-circular cross-section, a cross-section having at least one convex side portion, at least one edge angled with respect to the housing longitudinal axis or airfoil cross-section.

11. The apparatus of claim 1 wherein the first housing portion includes an outer periphery sized and configured for sealing engagement with the manifold of the fluid flow meter, the first housing portion including a peripheral seal around the outer periphery.

12. The apparatus of claim 11 wherein the outer periphery of the first housing portion defines at least one peripheral annular channel and the peripheral seal includes an O-ring disposed within the at least one peripheral annular channel.

13. The apparatus of claim 9 wherein the peripheral seal includes a conformal seal.

14. The apparatus of claim 2 wherein the first housing portion includes an outer periphery defining an opening extending therethrough and the fluid flow sensor extends at least partially through the opening, the apparatus further including:
a header comprising an electrical connector,
a plurality of electrical connections conductively coupling the fluid flow sensor to the connector; and
an internal seal occluding the opening to prevent the flow of fluid from the fluid flow channel through the opening of the first housing portion.

15. The apparatus of claim 14 wherein the internal seal comprises one of a conformal seal and a gasket.

16. The apparatus of claim 9 further including a manifold that defines the fluid flow channel, the manifold including a mounting opening, the first housing portion disposed within the mounting opening, wherein the housing longitudinal axis is angled with respect to the first direction by an angle between 0 degrees and 10 degrees.

17. The apparatus of claim 16, wherein the longitudinal axis extending through the second housing portion from the leading edge portion to the trailing edge portion is angled with respect to the first direction by less than or equal to 5 degrees.

18. The apparatus of claim 1 wherein the fluid flow sensor comprises:
a substrate; and
first and second sensor elements mounted on the substrate and operative to provide an electrical output signal indicative of a differential temperature between the first and second sensor elements.

19. A method for measuring a flow rate of a fluid flowing in a first direction through a fluid flow channel, the method comprising:
providing a housing including a fluid flow sensor mounting portion having a recess of depth d in at least one side of the fluid flow sensor mounting portion; and
mounting the fluid flow sensor at least partially within the recess, the fluid flow sensor having including a substrate having a side edge with a thickness t and a sensing element disposed on the substrate, such that at least a portion of the thickness t is disposed within the recess of depth d, wherein the recess is disposed between opposed first and second sensor mounting portion ends, the opposed first and second sensor mounting portion ends defining a housing longitudinal axis therethrough.

20. The method of claim 19 further including mounting the housing within a fluid flow meter with the housing longitudinal axis generally parallel to the first direction.

21. The method of claim 20 further including mounting the housing within a fluid flow meter with the housing longitudinal axis angled between 0 and 10 degrees with respect to the first direction.

22. The method of claim 21 wherein providing the housing comprises providing the housing having first and second mounting portion ends wherein at least one of the first and second mounting portion ends includes a cross-section having rounded corners, a generally semi-circular cross-section, a cross-section having at least one convex side portion, at least one edge angled with respect to the housing longitudinal axis or an airfoil shaped cross-section to provide reduced turbulence in a vicinity of a fluid flow sensing element of the flow sensor mounted within the recess.
